(19) United States
(12) Patent Application Publication
(10) Pub. No.: US 2005/0145695 A1
(43) Pub. Date: Jul. 7, 2005

(54) Process and device for electronic voting

(76) Inventor: Michael Bryan Kelly, Safety Harbor, FL (US)

Correspondence Address: Michael B. Kelly, 215 Woodland CT, Safety Harbor, FL, 34695, US

(21) Appl. No.: 10/751,319

(22) Filed: Jan. 5, 2004

(51) Int. Cl. G06F 17/60

(52) U.S. Cl. 235/386

(57) ABSTRACT

As electronic voting system and attendant processes providing a machine printed ballot, ballot verification, and automated ballot counting. This system provides an unalterable record that can be used to verify the system and the results of the voting process. This system is capable of proving clear and unambiguous evidence that the voting process can and has produced an accurate representation of the voter's selections. This electronic voting system contains the following listed subsystems: A subsystem providing a method for the voter to make their selections and provide those selections on printed media known as a ballot. A separate subsystem providing a method to verify that the ballot meets the voter's requirements and meets the requirements of the voting system. A separate subsystem providing a method and means to read the contents of individual ballots, accumulate the voting the results, and retain the ballots for future use.

### BACKGROUND OF THE INVENTION

1. Field of Invention

This invention is in the field of electronic voting devices.

2. Description of Prior Art

This invention is concerned with the concept of an electronic voting system that the general public can use and be confident that it is highly resistant to tampering and unlikely to exhibit unauthorized or unexpected behaviors.

For many years we have searched for methods to make voting more reliable, cheaper, and easier for the voter. The goals of reliability, cost, and easier to use are not exceptionally difficult to obtain. The most difficult factor is to convince the general public, and computer science experts in particular, that the system is truly reliable. An electronic voting system will use a significant amount of software. There is no known method of proving that any given piece of software has no defects. There is no known method of proving that any software item does what it should do, all it should do, and nothing it should not do. There is no known method of proving that any software product is not subject to fraud, tampering, and other means of disturbing its operations or its results.

Voting devices and process are not exempt from these problems. The public is rightfully concerned with the reliability aspect of the software. The subject of this application is to provide a method of electronically recording voter choices in a predictable manner.

U.S. Pat. No. 4,774,665

U.S. Pat. No. 4,774,665 to Webb (1988) provides for an electronic voting system, hereafter referred to as the Webb system. The Webb system is concerned with specific devices for the process of voting. The Webb system does not provide for a clear method of verifying that the ballots are correct. The Webb system provides no separation of the ballot generation, verification, and recording processes. The Webb system provides for communications with a central location. Any and all communications links with a remote station provide opportunities for unauthorized and undetected alterations and fraud. The system of this application, referred to as this system, specifically eliminates remote communications. The Webb system has multiple claims concerned with the standard ballot box. This system is not concerned with a standard ballot box. The Webb system is concerned with a special box to prevent unauthorized viewing of the ballot. A special box to prevent viewing is not required. Any closed box made of an opaque material will suffice as a collection box. The Webb system does not provide for separation of ballot generation, verification, and recording. A lack of separation provides opportunity for hidden defects that may alter the voter's selections. A lack of separation of functionality may make detection of alterations and fraud impossible. This system specifically separates these functions in order to provide simple and unambiguous proof that the results are as the voters intended.

U.S. Pat. No. 6,662,998

U.S. Pat. No. 6,662,998, to McClure, et al (2003), referred to as the McClure system is concerned with access to disabled voters. The subject of this application is not specifically concerned with disabled voters.

U.S. Pat. No. 6,641,033

U.S. Pat. No. 6,641,033 to McClure and Lohry (2003), referred to as the McClure Lohry system, is concerned with a central computer system and an absentee ballot manager agent. Neither is applicable to the intent and purpose of this system. The McClure Lohry system is further concerned with mobile memory unit and communications with a central location. Neither is applicable to this system. The McClure Lohry system is concerned with a paper ballot and its production. This system's primary concern with the paper ballot is its readability and its ability to transport information from one device to another.

The McClure Lohry system references an Internet communications. This system specifically avoids communications between the voting system and any central counting location.

The McClure Lohry system is concerned with ballot information and distribution of ballot information to polling stations. In the context of the McClure Lohry application ballot information is, essentially, the ballot before the voter has voted.

Further Prior Art

There are several other inventions that are concerned with the formatting and printing of the ballot, FLASH memory, mobile memory units, and remote communications. None have been found that are specifically designed to provide methods to ensure and verify that the voting process is secure and tamper resistant. Further, no other system is concerned with making the proof of the system obvious to those not skilled in the computer sciences. The need for a verifiable voting system has only recently become apparent resulting in little time for directly applicable prior art to have been developed.

Objects and Advantages

1. One object of this process and device is to provide a voting system that is secure and resistant to all types of tampering. The processes and devices of this application organize standard hardware and software into a cohesive system with new and unique characteristics.

2. A further object is to provide proofs of all the security and tamper resistance objects in such a manner that the untrained examiner will be satisfied and convinced that the proofs are accurate and valid.

3. A further object is to provide a method of reviewing the voter's choices.

4. A further object is to provide a physical ballot for use in verifying that the voter selections were counted correctly.

5. A further object is to verify that the physical ballot is correct and is not subject to errors.

### BRIEF SUMMARY OF THE INVENTION

The voter uses a computer controlled display and an input device to make their selections. When the voter has completed their selections, a hard copy ballot is printed. The voter inspects the ballot and verifies that it represents the desired selections. The voter inserts the ballot into a verification reader. The selections contained on the ballot are displayed to the voter. The voter verifies the selections. This verification step gives the voter confidence that the ballot represents their choices. The voter inserts the ballot into a recording reader where the ballot is read and the results recorded. The ballot is retained within the recording reader and the process is complete. All ballots are counted electronically. Hard copies of all ballots are preserved for recounts and verifications.

### BRIEF DESCRIPTION OF THE FIGURES

FIG. 1 depicts the basic flow of the voting procedure.

FIG. 2 depicts the actual selection activities which are continued in FIG. 3.

FIG. 3 depicts the voter's review of their selections and printing the ballot.

FIG. 4 depicts the ballot verification process

FIG. 5 depicts the ballot recording process.

FIG. 6 depicts a typified voting selection device.

FIG. 7 depicts the display from FIG. 6 showing two typified voting categories.

FIG. 8 depicts a typified ballot verification system

FIG. 9 depicts a typified ballot recording system

### DETAILED DESCRIPTION OF THE INVENTION

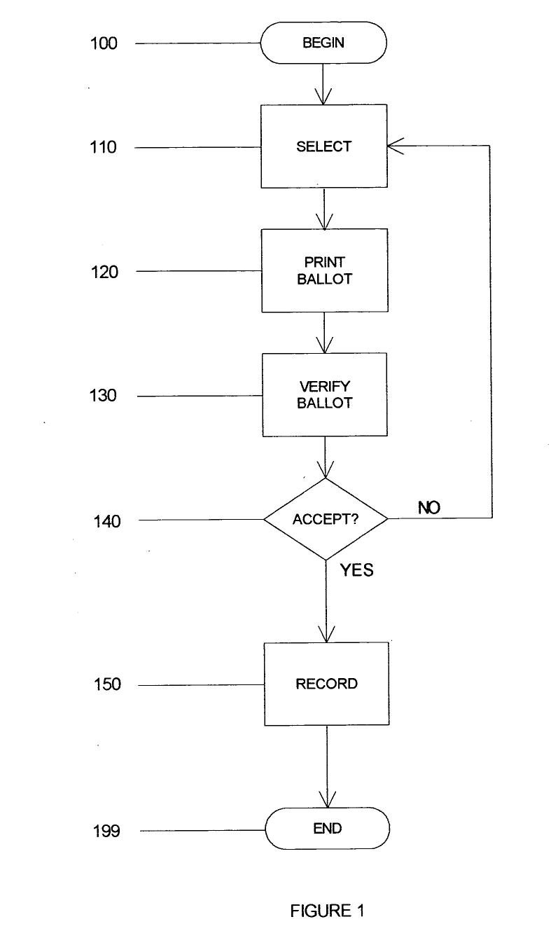

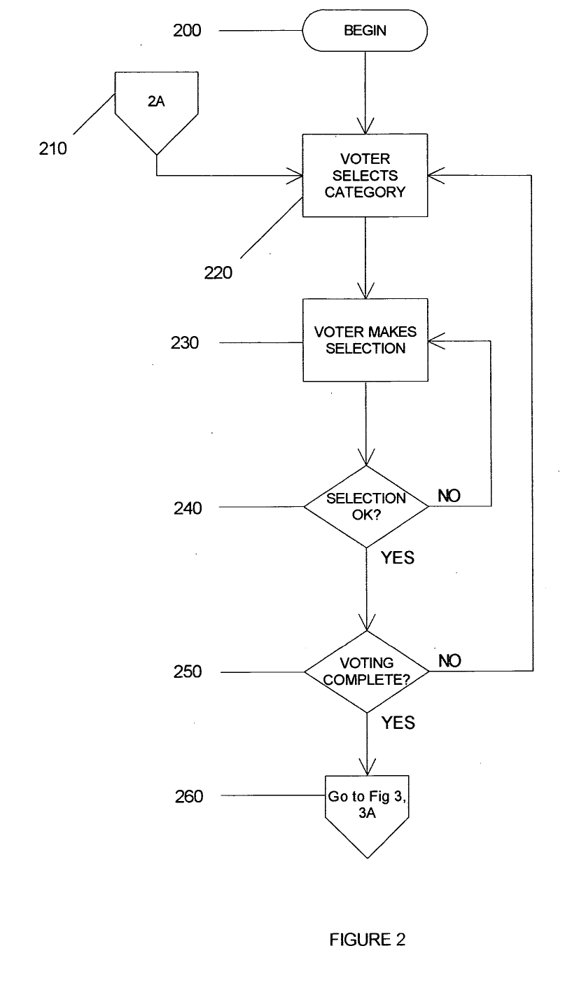

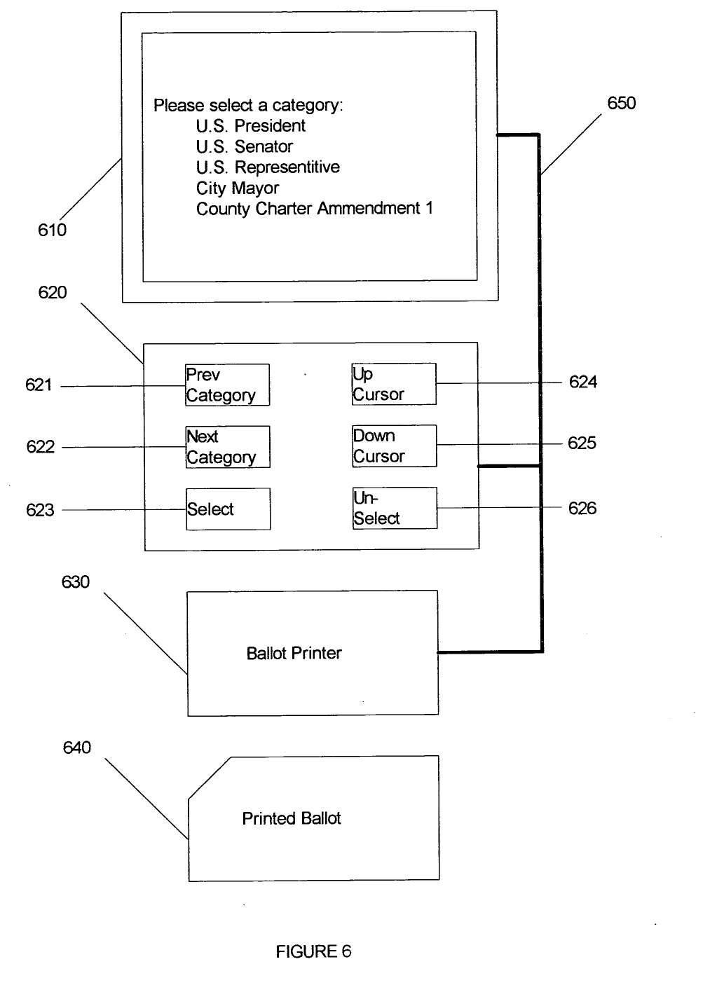

This section presents the detailed description of a typified embodiment of an electronic voting system. This section begins with some definitions applicable throughout this application. The description begins with a discussion of the process. The entire process is defined at a high level in FIG. 1. The process is subdivided into three sub processes and each is described with additional details in FIGS. 2, 3, 4, and 5. Following the process description are the descriptions of the devices used to implement the process in FIGS. 6, 7, 8, and 9.

Definitions

The purpose of these definitions is to reduce the amount of verbiage required to express a concept. Rather than to tightly define a meaning, the purpose of these definitions is to identify and group concepts facilitating the use of more elegant and succinct descriptions. The definitions are in alphabetical order.

Ballot: The ballot is the generally printed version of the voter's choices. It contains the voter's selection for each category.

Category: Within a voting process, a voter will generally make one selection in each of several categories. A category may consist of, for example, a grouping of people vying for the office of president, senator, mayor, council member, or any other elective position. The category represents the office while the selections are the individuals who wish to be elected to that office. A category may also include a single question or option that is answered with yes or no, or maybe with approved or rejected. Examples include an amendment to the state constitution or a referendum put to the voters.

Machine readable: A ballot is said to be machine readable when it contains data that can be read by some type of machine or computing device.

Polling team: Any governing representatives conducting a voting process or providing advice or instructions concerning the voting process are members of the polling team. The polling team identifies legitimate voters and provides assistance as needed.

Printed ballot: The printed ballot contains the voter's selections. A printed ballot can be piece of paper, a card, or any other device the voter information can be printed on, attached to, or otherwise embedded in or on, in such a manner that the information can be read or otherwise obtained from the printed ballot. A ballot may be printed using Braille for tactile sensing or with other unspecified methods for other means of sensing.

Process: The processes are the activities performed to complete the functions of this invention. Every device has a process by which it is used. In order to read a ballot with an electronic reader the user must follow the process of inserting the ballot into the reader and observing its display device to discover the contents of the ballot.

Selection: The selection is the choice the voter makes within each category. Within a category the voter will generally be allowed one option from a set of choices. For example, the voter will be allowed to pick only one person for office of President of the United States.

System: The system is the hardware that implements the voting process. The distinction made is that process is the activities and system is the hardware.

Technically correct: A ballot may contain not only the user's selections, but also various checksums and/or other validation values. When the ballot is read and the checksums and any other validation values are determined to be correct, the ballot is declared technically correct.

The voting procedure: The specific term “the voting procedure” refers to the entire process and all steps necessary for a single voter to complete their voting activity.

Overall Description of the Voting Process

The voting process flow chart begins on FIG. 1 at entry point 100. Selection process 110 is starts when a voter arrives at a voting station. In this process the voter is presented with a category and the selections for that category. The voter makes their selections for the various categories.

After the selection process has been completed the ballot is printed via print ballot process 120. The ballot is printed in one or more formats such that it is both human readable and machine readable. At the conclusion of the print ballot process the voter has a printed ballot in hand.

When printing is complete the voting process advances to verify ballot process 130. The voter passes the ballot through a verification system that reads the ballot and presents the choices to the voter on a display device. The voter observes the selections to verify that they are as expected. Decision point 140 signifies the voter's final decision to accept or reject the ballot as printed. If the voter is satisfied with the ballot the YES option of the decision process is taken and the voter continues to recording process 150. If the voter is not satisfied with the ballot, the NO option of decision point 140 is taken. The voter can request assistance from the polling team who can assist them in returning to the selection process.

Recording process 150 begins after verification is complete. The voter presents the ballot to the recording device. The ballot is accepted, read, and verified to be technically correct. The selections of the ballot are summed and the ballot is placed in a storage bin. Termination item 199 indicates that the voting process is complete.

This completes the high level description of the voting process.

Detailed Description of the Selection Process

The voting process is subdivided into three major sub processes, the selection process, the verification process, and the recording process. This application has the intent of separating the voting process into distinct sub-processes. As such, these three processes are discussed in isolation from each other. These three sub processes are now described with additional detail.

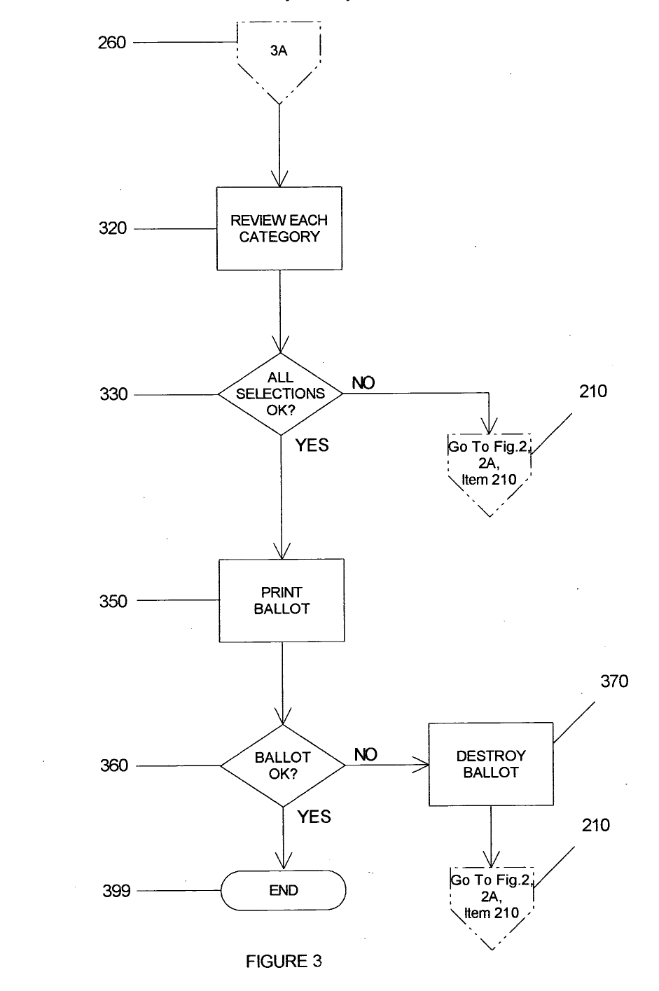

FIGS. 2 and 3 present a description of the selection process and was represented in FIG. 1 by processes 110 and 120. The selection process includes the ballot printing process. The discussion begins with FIG. 2 at entry point 200.

Off page connection point 210 is an entry point from other figures. Selection process 220 is where the voter determines the category. The system provides the voter with a list of categories. The voter selects one category for display. When the category has been selected, the selection device will display that category and the options available to the voter within that category. Process 230 depicts the activity of the voter making a particular selection within a particular category. The selection details are common knowledge and not significant to this discussion. After completing selections within a category, decision process 240 is entered. If the voter is not satisfied with their selection within the current category, the NO option of 230 is taken and the voter returns to selection process 230. If the voter is satisfied with their selection the YES option is taken and they continue on to decision process 250.

If there are additional categories that require selections, they are listed on the display device. The voter may select a new category. The selection of a category effectively selects the NO option of 250 and performs process 220. As a result the voter is returned to selection process 230. The voting process continues as previously described.

The voting process will cycle through process 220, 230, 240, and 250 until the voter has visited all categories. When all categories have been visited, the voting process exits FIG. 2 via connection point 260 and continues in FIG. 3.

Referring to FIG. 3, the voting process continues from connection point 3A, item 260, shown in an alternate position. In review process 320 the voter selects each category and views all the selections within that category. If a selection is not as desired, the NO option of decision point 330 returns the voter to the to the selection process of FIG. 2 via connector 2A, item 210 shown in an alternate position. When the selections are as desired by the voter, the YES option of decision point 330 is taken and the voting process continues on to process 350, print the ballot.

When the voter has determined that they have made the selections they desire, the voter elects to print the ballot. The ballot is printed in process 350. The printing process and device may calculate various checksums or other validation and verification calculations. These values can be printed on the card to ensure that the readers accurately read the data contained on the card. In decision point 360 the voter examines the human readable sections of the ballot to determine if the correct selections have been printed. If not, the NO option of decision point 360 is taken, the faulty ballot is destroyed via process 370, and the voter begins the selection process again via off page connector 2A, item 380. Assistance from the polling team is not mandatory but will probably be utilized to destroy the ballot. If the selections are acceptable to the voter, the YES option of decision point 360 is taken and the selection process of FIGS. 2 and 3 is complete.

The end point 399 of FIG. 3 marks an important delineation point. While the selection process of FIGS. 2 and 3 is a part of the entire voting process, it is a distinct process. Specifically, the selection process is separated from the verify process and separated from the record process. Other than the printed ballot, hand carried by the voter, there is no communications between any of the three processes of selection, verification, and recording. The restriction of communications between the three processes being limited to the printed ballot is an essential component of the ability to verify the entire voting process. This concept will be referenced later in this application.

Detailed Description of the Verification Process

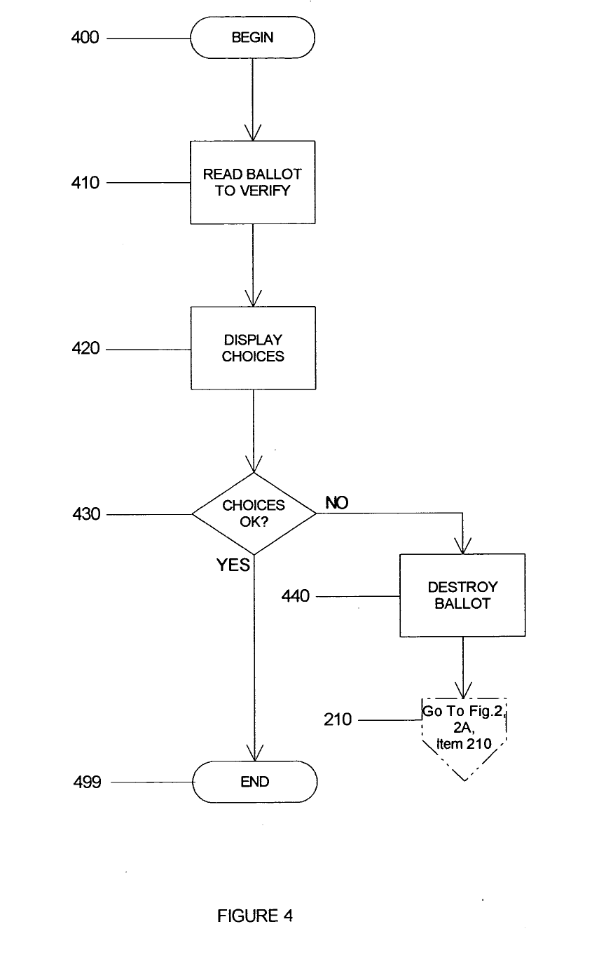

The verification process is depicted in FIG. 1 as items 130 and 140. Additional detail is now presented in FIG. 4. This verify ballot process is optional to the individual voter. The voter may elect to perform this process or proceed directly to the recording process. The verification process begins with entry point 400. Process 410 is the reading of the ballot by a device. The ballot is placed in the verification reader and is read. If all the checksums and validation values are correct verification continues with process 420. The reading system displays the voter's choices on a display device. Within process 420 the voter displays the various categories and selections that the ballot contains. The voter is, or should be, aware that they are viewing the ballot as the machine reads the ballot. This provides the voter with a level of confidence that the ballot accurately represents their choices.

In decision point 430 the voter determines if the display selections match their intended choices. If the ballot does not accurately represent the voter's choices, the NO path is taken and the ballot is destroyed via process 440. The verification process is terminated and voter returns to the selection process via off page connector 210, shown in an alternate position, into entry point 2A of FIG. 2. If the voter deems the ballot satisfactory, the YES option of decision point 430 is taken and the verification process concludes in termination point 499. In a manner similar to the selection process, this verification process is a sub-process of the selection process, but it is also a complete process within itself.

Detailed Description of the Recording Process

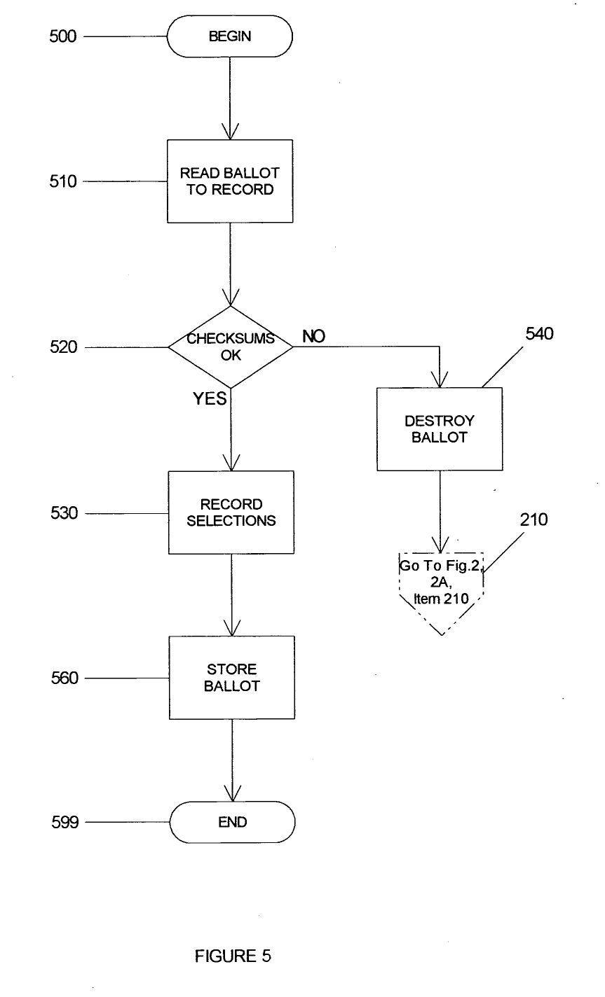

The recording process was depicted in FIG. 1 as item 150. FIG. 5 provides additional detail about the recording stage of the voting process. The process begins with entry point 500. The voter inserts the ballot into the recording reader and the ballot is read. The reader verifies that the various checksums and other validation fields are correct. In decision point 520, if the reader determines that the ballot is technically correct, the NO option of decision point 520 is taken. The ballot is destroyed via process 540, the recording process is exited and the voter returns to the selection process of FIG. 2 via off page connector 210 shown in an alternate position. If the ballot is determined to be technically correct, the YES option of decision pointer 520 is taken. The selections are recorded in process 530 and summed in the appropriate numeric counting fields within the recording device. The ballot is then retained in process 560 for future use. The recording process ends in termination point 599. This concludes the voting process.

In a similar manner to the selection process and the verification process, the recording process is complete within itself.

A Summary of the Voting Process

The voting process has been described to the point that a person with ordinary skills in computing machinery and software, and with ordinary skills in the voting process should be able to understand the basic flow. In review, the fundamental steps to the voting process are:
1. The voter makes their selections and the ballot is printed
2. The ballot is verified by the voter as being correct
3. The ballot is recorded and retained for future use.

The separation of the voting process into separate and distinct processes is an essential concept.

Detailed Description of the Selection Subsystem

The voting system, or hardware, is divided into three sub systems that match the sub processes and are used to implement those processes. They are the selection system, the verification system, and the recording system. As noted in the process descriptions above, the hardware systems are complete within themselves and communicate only via the one way path of the printed ballot. The description of these three systems will clarify that communications concept.

FIG. 6 depicts a typified selection subsystem. This typified system is composed of item 610 a combination display and computing unit item, item 620 a typified and simplified keyboard for the voter to input selections, item 630, a printer to print the ballot, and item 640 the ballot. Display 610, keyboard 620, and printer 630 are connected together via cable 650.

Note that cable 650 is the only communications link that can be used by devices 610, 620, and 630. The cable has no further connections.

Keyboard 620 and keyboard keys 621 through 626 are used to navigate through the selection system and its processes. The keys are now identified:
621 Prev Category, Navigates through the category selection in a reverse or up direction.
622 Next Category, Navigates through the category selection in a forward or down direction.
623 Selects, Selects the option that is currently under the cursor, be it category or “selection” as previous defined.
624 Up Cursor, Cursor movement
625 Down Cursor, Cursor movement
626 Un-Select, If a “selection” has been made this removes that selection. I.e. Removes a vote within a category.

Keyboard 620 is not a real keyboard, but a typified device used as a vehicle to describe the operations of the selection system. The specific manner and specific keystrokes used by the voter to navigate through the categories and to make their selections is not significant to subject of this application. The keyboard and keys may be replaced with a standard PC keyboard, with a mouse, a trackball, a touch screen, or any other input device that enables the voter to make their selections.

Display and computing device 610 can be any standard computer and display device. It works in conjunction with keyboard 620. Computing and display device 610 can use an unspecified software package to display the categories and selections to the voter. Regardless of the particular software package selected, the function remains the same.

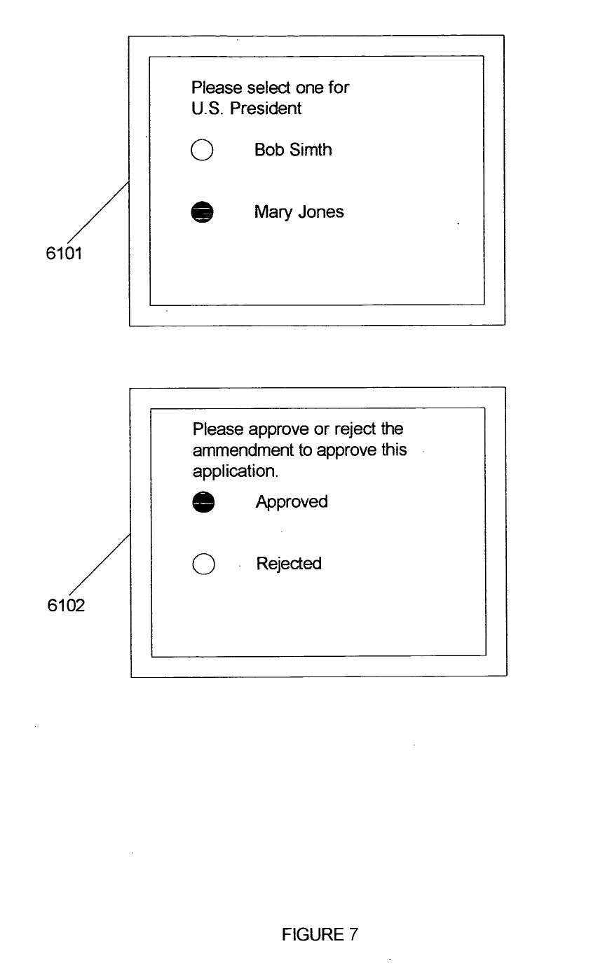

Display device 610 of FIG. 6 depicts a typified menu providing the voter with the means to select a category. FIG. 7 shows the display device with two possible displays. Display 6101, pronounced six ten one, depicts display 610 when presenting a typical multi-choice selection to the voter. Display 6102 depicts a display for a typical yes no type of selection.

Discussion now returns to FIG. 6. After the category has been selected, display device 610 displays the selections within a category. The voter is then provided the opportunity to make their selection for the displayed category.

The exact combinations of hardware and software needed to conduct the actual selection process are well known to those with an average skill in the computer sciences and methods of voting. The details are not significant to this application and are not presented here.

When the voter has completed the selection process they will be provided the ability to print ballot 640. Printer 630 prints or otherwise causes the ballot to be generated. The printer can take any one of a multiplicity of formats and design.

Regardless of the specifics of construction the printer generates the ballot meeting three specifications.

First, the ballot is human readable.

Second, the ballot is machine-readable.

Third, the ballot is printed using a publicly available and non-proprietary format(s) for human readability and specifically for machine readability.

Optionally, the printer may print one or more checksums or other types of validation values on the ballot. The purpose of these checksums or validation values is to verify that a machine reading device has read the ballot correctly.

The purpose using of a publicly available format is to allow the ballot to be read by commercially available systems that are external to the voting process. This ability serves as one of the verification points for the entire voting system.

The presence of the physical printed ballot that can be touched, handled, and read by the voter is an important part of the voting process. This physical ballot and the processes and systems that utilize and reference the ballot enable the voter to be confident that their votes are recorded as they intend.

Detailed Description of the Verification Subsystem

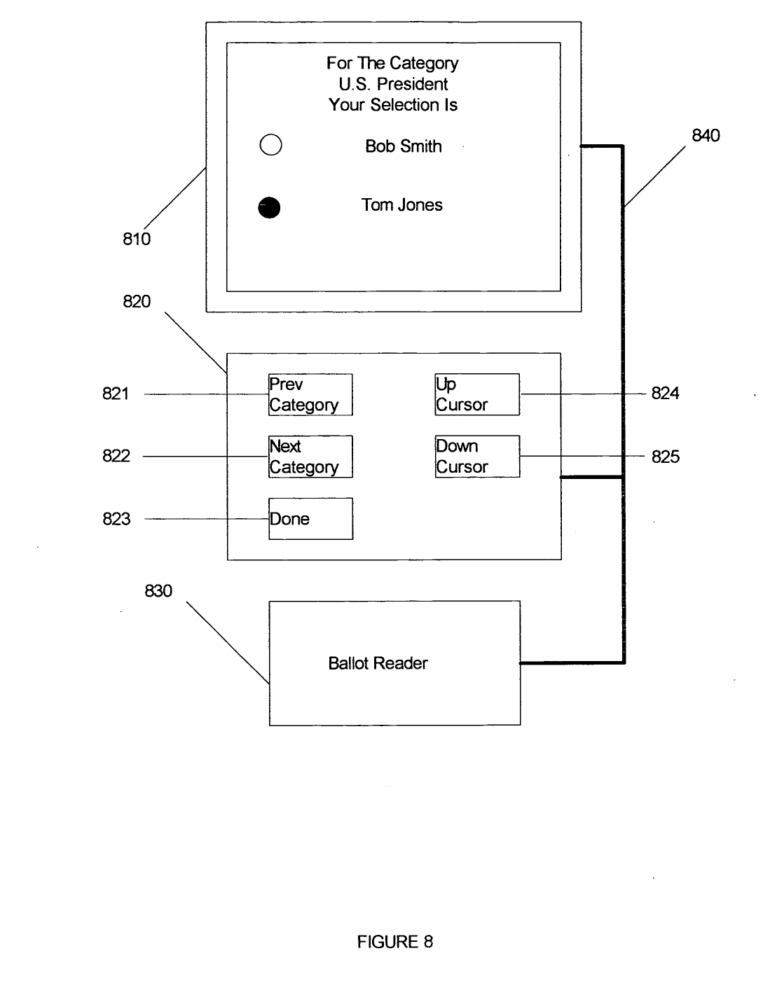

FIG. 8 depicts a typified verification subsystem. The verification system is composed of computing and display device 810, keyboard 820, ballot reader 830, and connecting cable 840.

In accordance with the verification procedure previously described, the voter presents the ballot to reader 830. The contents of the ballot are read and displayed on display device 810. In a manner similar to selection computing and display device 610 the voter's selections are displayed. The contents of the ballot are displayed but cannot be changed. Keyboard 820 and keys 821 through 825 may be used to navigate through any plurality of categories presented to the voter. The keys of keyboard 820 are now listed.
821 Prev Category, Navigates through the category selection in a reverse or up direction.
822 Next Category, Navigates through the category selection in a forward or down direction.
823 Done, The voter has completed verification. Erase the selections from the display and the computer.
824 Up Cursor, Cursor movement
825 Down Cursor, Cursor movement

As noted for the selection, keyboard 820 is a typified keyboard used for explanations only. Keyboard 820 and attendant keys may be replaced with other devices.

The verification system provides the voter the ability to review the printed ballot as read by a device that is functionally identical to the recording device. The previously described verification process describes the activities involved in verifying the printed ballot.

Note that connecting cable 840 is limited to display 810, keyboard 820, and reader 830. As specified in the selection system, these items have no communications path with any other system or subsystem. This is an important part of the verification of the entire voting system.

Further note that as previously stated the machine readable portion of the ballot is formatted per publicly available standards. Reading devices created by manufacturers other than the prime manufacturer of the voting system may be used to read the ballot. The ability to read the ballot and obtain the same results as the voting system described herein provides a verification point for the entire voting process and voting system.

Detailed Description of the Recording Subsystem

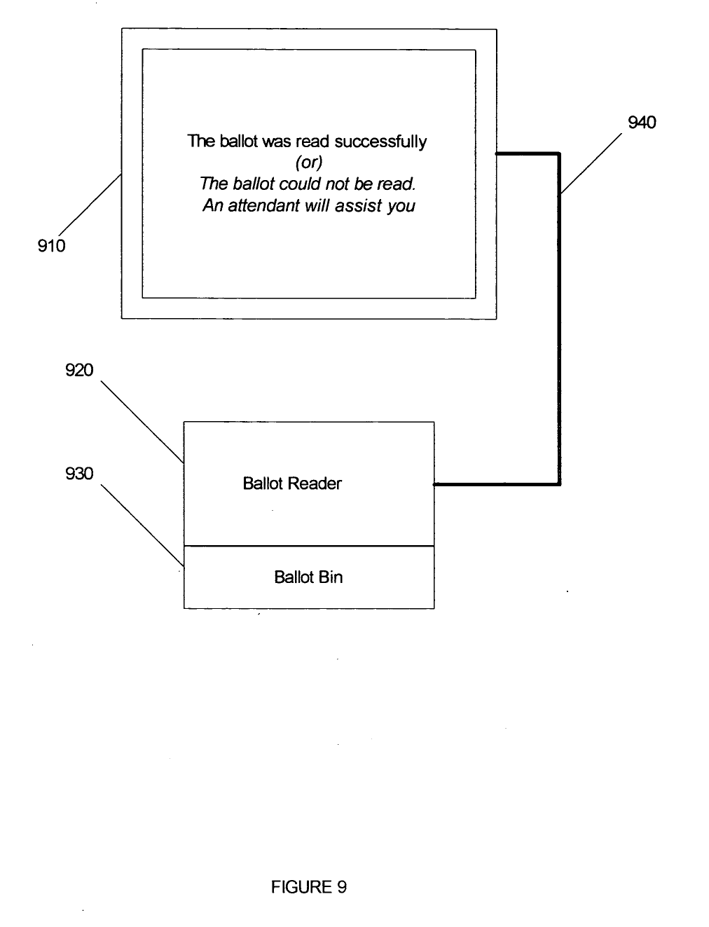

FIG. 9 presents the recording system consisting of computing display device 910, ballot reader 920, ballot bin 930, and connecting cable 940.

The ballot is placed in the ballot reader. The reader accepts and reads the ballot and presents the ballot information to computing and display device 910. The data from the reader is evaluated and determined to be technically correct or incorrect. If the data is invalid the ballot is rejected, returned to the voter, and the selections are not summed. If the data is valid the ballot is accepted, the selections contained on the ballot are appropriately accumulated and sent to the ballot bin for retention and future use. The previously described recording process defines the activities of recording.

The selection summing functions of the verification sub-system may be any type of summing device, electrical, mechanical, or otherwise. Multiple scenarios may be used to ensure that the final ballot counts are correct. However, the important concept is that all or part of the ballots may be read again. All ballots may be read by the same recording system, a different recording system, or a counting system manufactured by a different company. The requirement for a non-proprietary printing (encoding) format assists this concept. All ballots may be examined by hand and by machine for the purposes of verifying the final ballot counts and verifying the operation of the recording subsystem.

Note further that cable 940 connects the computing display and the reader. As before, the recording system has no other communications with any system or subsystem while engaged in the voting process. Again, this contributes to the ability to verify the entire voting system.

When the polling operations are concluded and the polls closed, the tallies for each recording machine are obtained from the recording system. The exact method is not specified. At this point the voting process has completed from the perspective of this application.

### CONCLUSIONS

This previously stated objectives of the system are now reviewed.
1. The object of creating a voting system that is secure and resistant to tampering has been met.
2. The objective of creating a voting system that is easily verified to be secure and resistant to tampering has been met.

The division of the voting process and system into separated parts advances both of the stated objectives. Regardless of the internal operations, the printed ballot is the only communications between the separate subsystems. If the ballot represents the voter's specifications, the code in the selection and printing system is right by definition. That definition is to print the ballot per the specifications. The printed ballot can be read by both voter and machine. It can be shown to be correct by the user of public coding standards and the ability to read the ballot with devices other than the printing device. The proof of the correct ballot is simple and obvious.

Incorrect or devious code in the selection system has no effect when the end result is a correctly printed ballot. Further, the inputs and outputs of the verification and recording systems are simple enough that they can be thoroughly tested through manual and automated repetition. The use of open source can enhance the sense of confidence that the software of all three components work as desired. The reduced complexity in each due to the division of responsibility aids the task of software verification.
3. The use of public printing standards and the presence of verification readers at the polling stations enable the voting system to meet the requirements of reviewing the voter's choices.
4. The objective of producing a physical ballot has obviously been met.
5. The objective of verifying the physical ballot as being correct in that it accurately represents the voter's choices has obviously been met.

As has been shown, the methods and system describes herein produce an electronic voting system that can be demonstrated to be correct to a very high degree of confidence. The advantages and proofs are demonstrable to a person not skilled in computer sciences.

The design and implementation of this system does not rely on what may currently be regarded as sophisticated hardware and software to produce a verifiably accurate and reliable system. This system is unique in the organization of the processes, the organization of the hardware, and the organization of the software. The combinations of the following concepts are unique to this voting system:
1. The use of a printed ballot.
2. The use of non proprietary format for printing the ballot
3. The ability to read and compare human readings of the ballot with machine readings of the ballot.
4. The ability to utilize equipment from other manufacturers to examine the printed ballot.
5. The division of the voting system into distinct but clearly separated functions.
6. The isolation of the system from all other communications links during the voting process.
7. The coordinated use of all the above features in a single functional system.

The details of the typified system describe herein are not to be regarded as limiting. They are to be regarded as an explanation of the concepts only. The embodiment described here is only to present the concepts. Multiple variations of this system can be envisioned by those skilled in the relevant sciences.

1) An electronic voting system comprising
a) a selection system providing the means for a voter to
i) view voting options,
ii) make voting selections,
iii) cause said selections to be printed on a ballot whereby said selections become part of the contents of said ballot, and
b) an electronic recording device providing the means to
i) accept said ballot, and
ii) read said selections from said ballot, and
iii) accumulate counts of selections from a plurality of said ballots, and
iv) retain a plurality of said ballots,
c) wherein said selection system has been designed or implemented such that
i) all information containing inputs to said selection system are generated by activities of said voter, and
ii) all outputs of said selection system are the said ballot, and
d) and all inputs to said recording system are either said ballot or a plurality of said ballots, and
e) all outputs of recording system generated during the voting process consists of said accumulated counts and said plurality of ballots that are retained within said recording device while said recording device is engaged in the voting process, wherein
f) only after the voting process for said recording device has been concluded or suspended, can said outputs of said recording system be accessed and
g) said outputs of said recording system are accessible only to members of the polling team in the physical presence of said recording system.

2) The electronic voting system of claim 1 wherein all said inputs to and all said outputs of said selection system and said recording system are observable by a person of ordinary skill in computer usage such that said person can ascertain that said outputs of said recording device are indeed results of proper usage of said electronic voting system.

3) The electronic voting system of claim 1 wherein said electronic voting system contains a verifying device providing a means for reading said contents of said ballot, and displaying said contents of said ballot to said voter such that said voter is able to ascertain that said contents of said ballot is in agreement with said selections previously made by said voter.

4) The electronic voting system of claim 1 wherein said electronic voting system prints said ballot using publicly available schemes providing the means for said ballot to be read by publicly available devices so said contents of said ballot can be ascertained to be as intended by said voter.

5) A method or process of secure voting comprising the steps of
a) making voting selections, and
b) producing a physical ballot readable by human and by machine, and
c) a recording reading of said ballot by machine in order to accumulate a plurality of said voter selections.

6) The secure voting method of claim 5 wherein there is an additional verification reading of said ballot by machine and an observation of the machine read contents of said ballot to ensure correctness of said contents of said ballot.

7) The secure voting method of claim 6 wherein said additional reading of said ballot is performed between said printing of said ballot and said recording reading of said ballot.
